(19) United States
(12) Patent Application Publication
(10) Pub. No.: US 2007/0256585 A1
(43) Pub. Date: Nov. 8, 2007

(54) Machine for washing flexographic printing plates

(75) Inventors: Alberto Zanoli, Sala Bolognese (IT); Stefano Sambri, S. Lazzaro Di Savena (IT)

Correspondence Address: MODIANO & ASSOCIATI, Via Meravigli, 16, Milan, 20123, omitted

(73) Assignee: BIEFFEBI S.P.A.

(21) Appl. No.: 11/790,499

(22) Filed: Apr. 26, 2007

(30) Foreign Application Priority Data
May 5, 2006 (IT) BO2006A000334

(51) Int. Cl. B41F 35/00

(52) U.S. Cl. 101/424

(57) ABSTRACT

A machine for washing flexographic printing plates, comprising a footing which forms at least one chamber for washing the printing plates, at least one shaft for supporting at least one printing plate in a cylindrical configuration arranged inside said washing chamber and associated with a first rotary actuation, at least one brush, with axis parallel to the axis of the supporting shaft and associated with a second rotary actuation and with a device for selective positioning from at least one inactive configuration to at least one washing configuration, in which the brush is in contact with the printing plate, at least one circuit for washing the printing plate and a dryer for drying the washed printing plate.

The present invention relates to a machine for washing flexographic printing plates.

### BACKGROUND OF THE INVENTION

It is known that flexographic printing is performed mainly by means of two types of ink: a first one which can be diluted with water and a second one which can be diluted with solvents (typically ethyl alcohol and ethyl acetate).

At the end of each printing operation, the printing plates that have been used must be washed accurately, so that they can be thus kept in good condition and can be reused at full efficiency. For each type of ink, washing entails several cycles, generally a first detersion cycle and a second rinsing cycle; the cleaning of the halftone etching of each printing plate, where the ink is deposited in a substantial quantity, is particularly critical.

Traditionally, and in relation to the different requirements of application, printing plates are used in different manners which are described briefly hereafter.

According to a first manner, the printing plates are mounted directly, by means of double adhesive, on respective steel printing cylinders: therefore, in order to be washed, the printing plates must be removed from said cylinders.

In a second manner of use, the printing plates are mounted on respective cylindrical blankets by means of double adhesive and are removed when their use for printing ends and are subsequently washed; said blankets are used with other plates in subsequent printing operations.

Finally, according to a third manner of use, the printing plates are mounted by means of double adhesive on respective blankets and are washed and stored as they are, without being removed. This method is used, among other things, to reduce the time required to mount the printing plates in register and also when the printing plate itself is completely wrapped around the blanket, for example to perform continuous printing (wallpaper, fabrics and the like).

Traditionally, washing of the printing plates, in view of the plurality of operating conditions in the printing industry, is mainly performed manually by the assigned operators, with all the necessary precautions against the danger constituted by solvents and with an obvious expenditure of time and production resources.

As an alternative, for some specific operating conditions of printing plates, dedicated machines have been provided, such as for example machines for washing the printing plates on a flat surface, but they are unable to meet the washing requirements in other situations, such as for example in the case of printing plates which are mounted permanently on the respective blankets.

### SUMMARY OF THE INVENTION

The aim of the present invention is to obviate the above mentioned drawbacks, by providing a machine for washing flexographic printing plates which allows to remove completely the printing ink from each printing plate in a versatile and effective manner, i.e., independently of the specific operating configurations of said printing plates and of the type of ink used in printing.

Within this aim, an object of the present invention is to provide a machine for washing flexographic printing plates which is adapted to minimize the time and cost allocated to washing said printing plates in an industrial context.

Another object of the present invention is to provide a machine for washing flexographic printing plates which is reliable and safe in use even when the printing process uses ink which can be diluted with solvent and therefore is flammable.

Another object of the present invention is to provide a machine having a structure which is simple, relatively easy to provide in practice, safe in use, effective in operation, and has a relatively low cost.

This aim and these and other objects which will become better apparent hereinafter are achieved by the present machine for washing flexographic printing plates, characterized in that it comprises at least one substantially box-like footing which forms at least one printing plate washing chamber, at least one shaft for supporting at least one printing plate in a substantially cylindrical configuration, which is arranged inside said washing chamber and is associated with first means for rotary actuation about its own axis, at least one brush, whose axis is parallel to the axis of said shaft and which is associated with second means for rotary actuation about its own axis and with means for selective positioning from at least one inactive configuration to at least one washing configuration, in which said brush is substantially in contact with said printing plate along a generatrix, at least one printing plate washing circuit and means for drying the washed printing plate, said supporting shaft being selectively associable with first means for mounting the printing plate removed directly from the printing cylinder or removed directly from the respective blanket, or with second means for mounting the printing plate which is fixed permanently to the respective blanket.

### BRIEF DESCRIPTION OF THE DRAWINGS

Further characteristics and advantages of the invention will become better apparent from the following detailed description of a preferred but not exclusive embodiment of a machine for washing flexographic printing plates according to the invention, illustrated by way of non-limiting example in the accompanying drawings, wherein:

FIG. 1 is a partially sectional front view of the washing machine according to the invention, with the first printing plate mounting means installed thereon;

FIG. 2 is a side elevation view, taken from the left, of the washing machine;

FIG. 3 is a side elevation view, taken from the right, of said machine;

FIG. 4 is a partially sectional front view of the washing machine with the second printing plate mounting means installed, said printing plate being fixed on a blanket having a small diameter;

FIG. 5 is a partially sectional front view of the washing machine with the second printing plate mounting means installed, said printing plate being fixed on a blanket having a large diameter;

FIG. 6 is another partially sectional front view of said machine;

FIG. 7 is a sectional side elevation view, taken from the left and along a central plane, of the washing machine with the brush in the inactive configuration and with the first printing plate mounting means installed;

FIG. 8 is a detail sectional side elevation view, taken from the left and along a central plane, of the washing machine, with the brush in the washing configuration and with the second printing plate mounting means installed;

FIG. 9 is a sectional side elevation view of the machine, taken from the right and along a central plane.

### DESCRIPTION OF THE PREFERRED EMBODIMENTS

In the exemplary embodiment that follows, individual characteristics may actually be interchanged with other different characteristics that exist in other exemplary embodiments.

Moreover, it is noted that anything found to be already known during the patenting process is understood not to be claimed and to be the subject of a disclaimer.

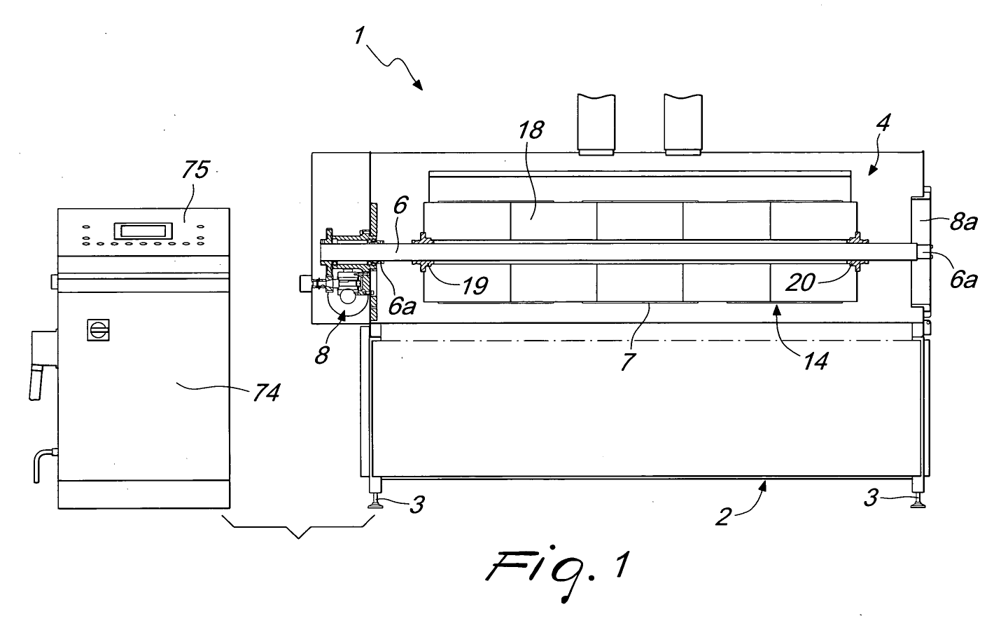

With reference to FIG. 1, the reference numeral 1 generally designates a machine for washing flexographic printing plates according to the invention.

The machine described hereinafter is capable of cleaning effectively printing plates in any operating configuration and used with all types of printing ink, from inks which can be diluted in water to inks which can be diluted in various solvents, including flammable ones.

The machine comprises advantageously a footing, generally designated by the reference numeral 2, which is substantially box-like, with supporting feet 3, and forms in an upper region at least one printing plate washing chamber, generally designated by the reference numeral 4.

The washing chamber 4 is provided with a substantially rectangular upper hatch 5 for mounting and removing the printing plates, as described in greater detail hereinafter; said hatch is pivoted and can be closed hermetically by means of a gasket.

The washing machine comprises a horizontal shaft 6 for supporting at least one printing plate 7 in a substantially cylindrical configuration, which is arranged within the washing chamber 4 and is associated with first means for rotary actuation about its own axis, generally designated by the reference numeral 8. The supporting shaft 6 is supported so that it can rotate in bearings 6a which are mounted at the side walls of the washing chamber 4.

The washing chamber further comprises at least one lateral hatch 8a, which is pivoted and is adapted for the insertion and removal of the cylinder or blanket of the supporting shaft 6 and can be closed hermetically; one of the bearings 6a for supporting the shaft 6 is fixed on the lateral hatch 8a.

Conveniently, there is at least one brush 9 for cleaning the printing plate 7, which has an axis which is parallel to the axis of the supporting shaft 6 and is associated with second means for rotary actuation about its own axis, generally designated by the reference numeral 10, and with means, generally designated by the reference numeral 11, for selectively positioning the brush 9 from at least one inactive configuration, in which it is substantially spaced from the printing plate 7, to at least one washing configuration, in which the brush 9 is substantially in contact with the printing plate 7 along a generatrix.

The machine conveniently comprises a circuit for washing the printing plate 7, generally designated by the reference numeral 12, and means for drying the washed printing plate 7, generally designated by the reference numeral 13.

In relation to the specific production requirements, the supporting shaft 6 of the machine according to the invention can be associated selectively with first means 14 for mounting the printing plate 7 removed directly from the printing cylinder or removed directly from the respective blanket 15, or with second means 16 for mounting the printing plate 7 which is fixed permanently to the respective blanket 15. This allows to achieve maximum versatility in cleaning the printing plates: as mentioned, printing plates used in any known configuration can in fact be cleaned quickly and effectively.

In greater detail, the first mounting means 14 for mounting the printing plate 7 comprise at least one cylinder 18, which has an appropriately sized diameter (and is for example internally hollow in order to save on weight and material used), affected by a respective through axial channel 18a for keying along the supporting shaft 6; the cylinder 18 is locked at the respective ends by way of two conical bushes 19, 20, which are fitted along the supporting shaft 6. In order to fix the printing plate 7 for washing, the cylinder 18 is conveniently lined with double-adhesive material, for example in tape form, of a substantially traditional type.

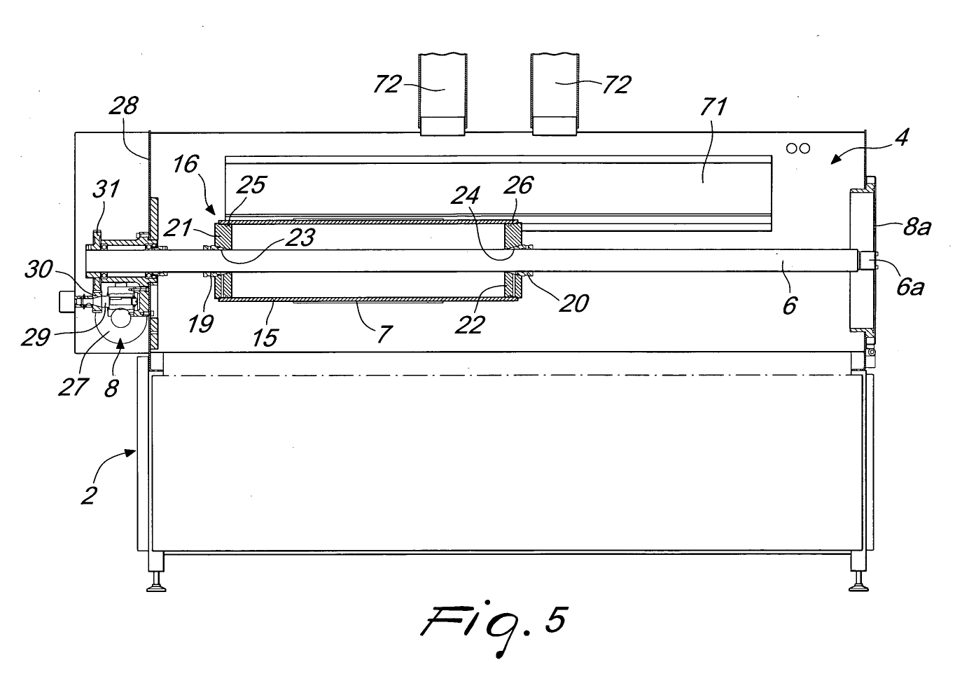

The second mounting means 16 for mounting the printing plate 7 (FIG. 5) comprise, in addition to the pair of conical bushes 19, 20 fitted along the supporting shaft 6, at least one pair of respective flanges 21, 22, which are substantially circular and have respective central holes 23, 24 in which the conical bushes 19, 20 engage. The flanges 21, 22 have respective shoulders 25, 26 which are adapted to lock bilaterally each blanket 15 along the supporting shaft 6 at each of its end faces. The flanges 21, 22 can be sized, in their diameter, so as to be able to mount blankets 15 of all the sizes currently used in industrial printing.

The first actuation means 8 for rotationally actuating the supporting shaft 6 about its own axis comprise at least one first gearmotor assembly 27, which is fixed externally to one side 28 of the washing chamber 4 and has a respective first output shaft 29 in which at least one first gear 30 is keyed, said gear meshing with a second gear 31, which is keyed at one end of the supporting shaft 6, said end extending outward from the footing 2.

The second actuation means 10 for rotary actuation of the brush 9 comprise at least one second gearmotor 32, which is fixed on the outside of the side 28 of the washing chamber 4 and has a respective second output shaft 33, which is supported in the washing chamber 4 and to the end of which a first pulley 34 is keyed for actuating a belt 35 for transmitting motion to a second pulley 36, which is keyed to one end of the shaft 37 for supporting the brush 9.

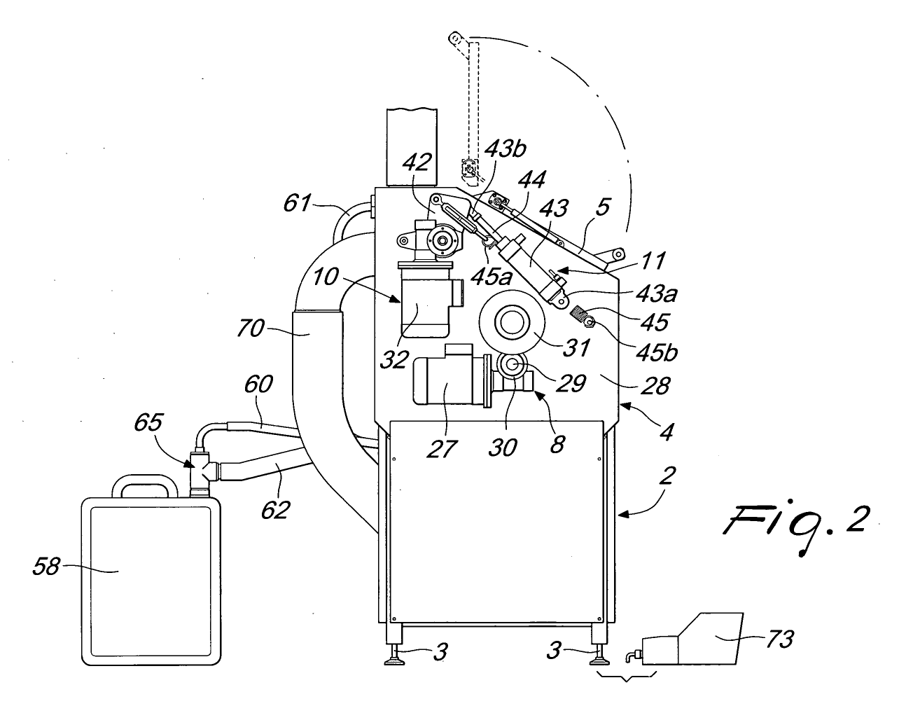

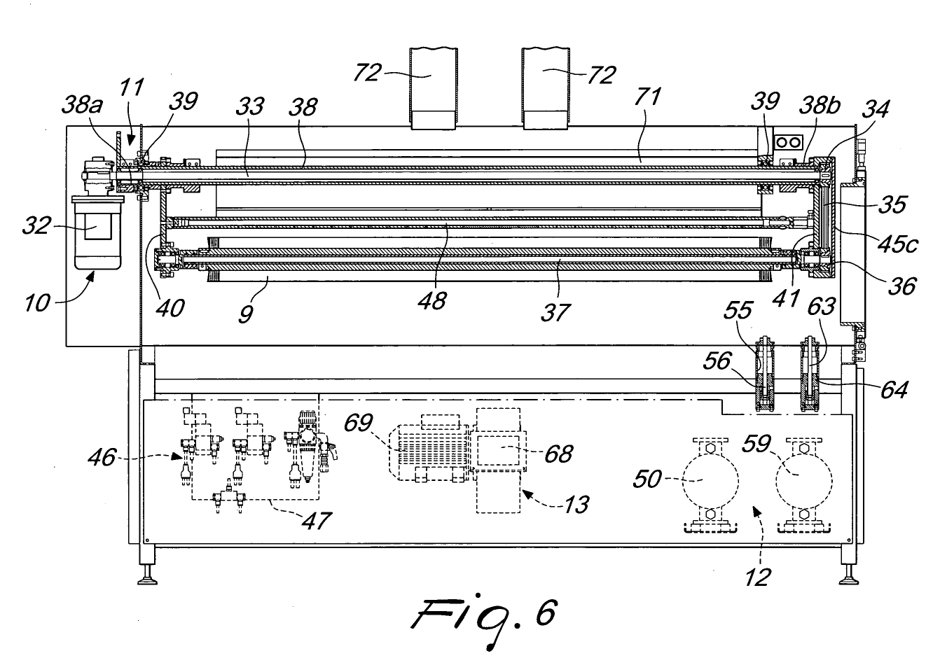

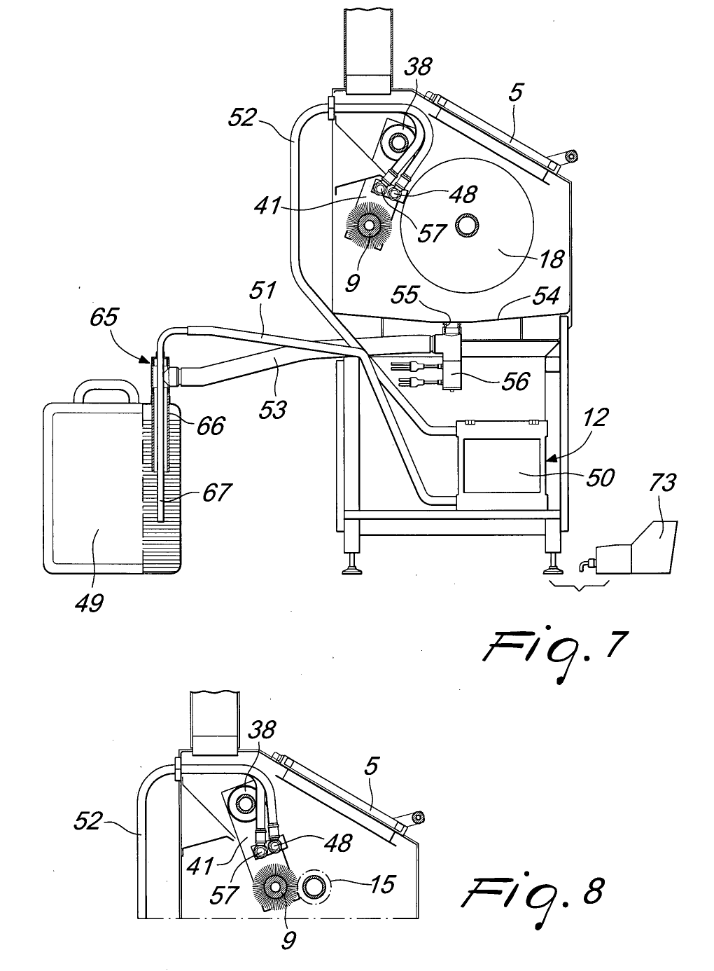

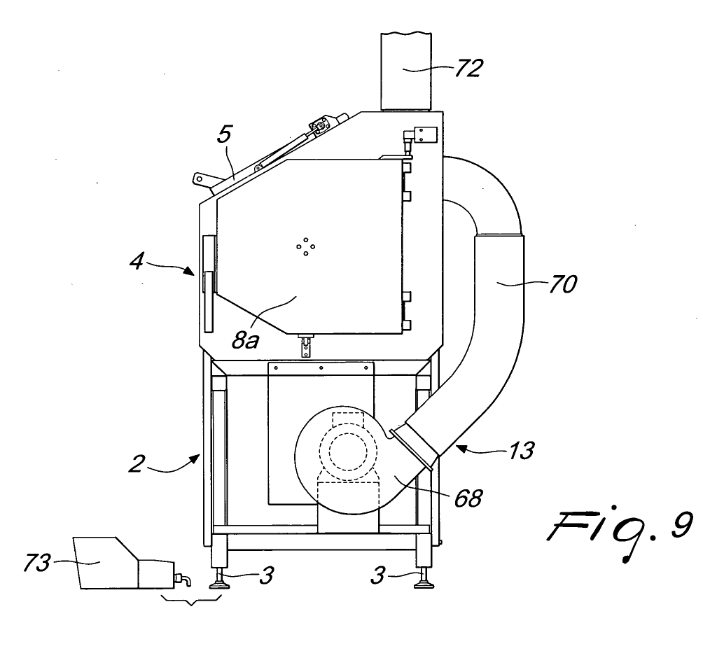

The positioning means 11 for selectively positioning the brush 9 (FIG. 6) comprise at least one tubular body 38, which has a proximal end 38a and a distal end 38b and is supported so that it can rotate by means of bearings 39 in the side 28 of the washing chamber 4, and two arms 40, 41 for rotationally supporting the ends of the shaft 37 of the brush 9 are rigidly coupled thereto; the proximal end 38a of the tubular body 38 conveniently protrudes outside the side 28 of the washing chamber 4 and a rocker 42 is fixed rigidly thereto. The positioning means 11 further comprise (FIG. 2) at least one linear actuator 43, which lies outside the washing chamber 4 and has a first end 43a which is articulated to the side 28 of the washing chamber 4 and a second end 43b which is articulated to the rocker 42; the linear actuator 43 has a stem 44 which can be actuated so as to move from at least one retracted position, at which the rocker 42 and therefore the brush 9 are in the inactive configuration (FIG. 7), i.e., spaced from the printing plate, to at least one extended position, at which the rocker 42 and the brush 9 are in a configuration for washing the printing plate 7, in contact along respective generatrices (FIG. 8, in which the printing plate is mounted on the respective blanket 15). This allows advantageously to arrange in a mutually adjacent configuration the brush 9 and the printing plates 7 mounted on blankets 15 of any diameter and mounted on the cylinder 18.

The selective positioning means 11 further comprise at least one return spring 45, which has a first end 45a which is articulated to the rocker 42 and a second end 45b which is articulated to the side 28 of the washing chamber 4; the return spring 45 is conveniently adapted to keep the brush 9 in the inactive configuration of FIG. 7.

Conveniently, as shown in FIG. 6, the second output shaft 33 is accommodated so as to pass coaxially within the tubular body 38; the first pulley 34, the belt 35 and the second pulley 36 are instead accommodated within a box 45c, which is rigidly coupled to the distal end 38b of the tubular body 38 which lies opposite the side 28 of the washing chamber 4.

The linear actuator 43 is of the double-acting pneumatic type, which is associated with substantially traditional pneumatic actuation means 46, which are mounted on a respective panel 47 which is arranged in the lower portion of the footing 2.

The circuit 12 for washing the printing plate 7 comprises a first spray duct 48, which is parallel to the supporting shaft 6, which is fixed, at the ends, respectively to the arms 40, 41 and is affected by a distribution of ports for ejecting at least one first liquid onto the surface of the printing plate 7, the function of said liquid being described in greater detail hereinafter; the first liquid is collected in a respective first container 49 and is fed by means of a first pneumatic pump 50 which is fixed to the lower portion of the footing 2. There is in fact a first intake duct 51, which is connected to the first pump 50 (to the intake port), which is adapted to draw the first liquid from the first container 49, and there is at least one first delivery duct 52 for the first liquid, which is connected respectively to the first pump 50 (at the delivery port) and to the first spray duct 48.

The washing circuit 12 further conveniently comprises a first duct 53 for discharging the first liquid, which is connected at one end to the bottom 54 of the washing chamber 4 at a first discharge port 55 and at the other end to the first container 49; the first discharge port 55 is advantageously associated with a respective first valve 56 for selective opening and closure, which is of the electropneumatic type and is functionally associated with the pneumatic actuation means 46.

The washing circuit 12 further comprises a second spray duct 57, which is fixed, at the respective ends, to the arms 40, 41 and is affected by a distribution of ports for ejecting onto the printing plate 7 a second liquid, the function of which will become apparent hereinafter. The second liquid is collected in a respective second container 58 and is fed by means of a second pneumatic pump 59, which is rigidly coupled to the lower portion of the footing 2; there is a second intake duct 60, which is connected to the second pump 59 (intake port) and is adapted to draw the second liquid from the second container 58, and there is a second delivery duct 61 for the second liquid, which is connected respectively to the second pump 59 (delivery port) and to the second spray duct 57.

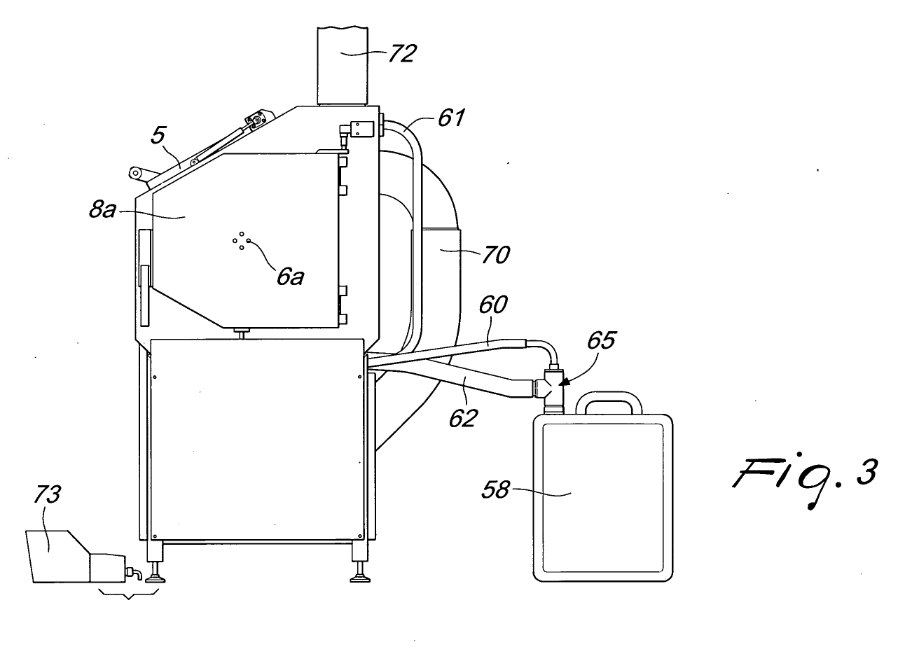

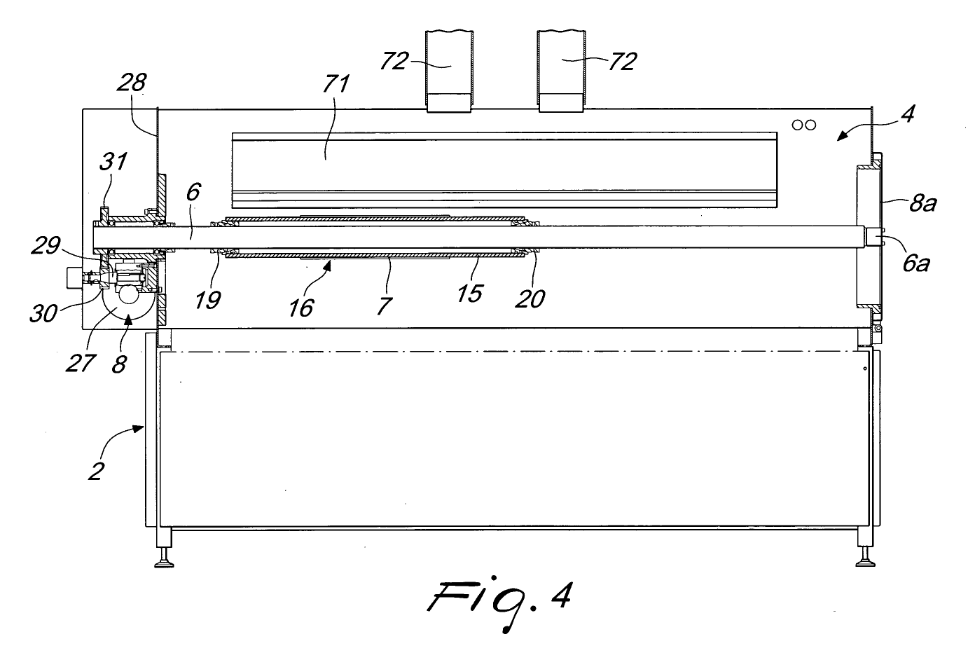

The washing circuit 12 further comprises (FIG. 3) a second duct 62 for discharging the second liquid, which is connected at one end to the bottom 54 of the washing chamber 4 at a second discharge port 63 and at the other end to the second container 58: the second discharge port 63 is associated with a respective second valve 64 for selective opening and closure, which is of the electropneumatic type and is functionally controlled by the pneumatic actuation means 46.

As shown in FIG. 7, both the first container 49 and the second container 58 are provided with a respective coupling 65 for the first and second intake ducts 51, 60 and for the first and second discharge ducts 53, 62; in greater detail, each coupling 65 comprises an external tubular element 66, which is inserted in the mouth of the container 49, 58, and is connected to the discharge duct 53, 62, and an inner tubular element 67, which has a smaller diameter, is inserted in the outer tubular element 66 and is connected to the intake duct 51, 60.

In relation to the type of ink used in printing, the first and second liquids used in washing are obviously of different kinds and are chosen appropriately.

If a water-soluble ink is used, the first liquid is constituted preferably by detergent and the second liquid is constituted by water.

In the case instead of ink of the type which is soluble in a solvent (ethyl alcohol and ethyl acetate), the first liquid is constituted by rough washing solvent and the second liquid is constituted by clean solvent for removing the last impurities.

The choice to perform washing with two liquids, however, is nonlimiting: it is in fact possible to use a plurality of liquids of any suitable nature, distributed in a number of washing cycles selected in each instance by the user.

The drying means 13 for drying the printing plate 7 after washing it comprise at least one fan 68, which is associated with a respective actuation motor 69 and is connected to at least one tube 70 for introducing air into the washing chamber 4; there is also at least one port 71 for discharging the drying air from the washing chamber 4, which has a horizontally elongated substantially rectangular surface and is connected to a tube 72 for discharging the air externally.

There is also a pedal 73 for actuating the rotation of the supporting shaft 6, which is functionally connected to the first rotary actuation means 8 and is indispensable for mounting and removing the printing plates 7 respectively before and after washing them.

The machine is controlled by an electrical cabinet 74, which is provided with a control panel 75 of a substantially traditional type for programming and managing the operations for washing each printing plate 7 (FIG. 1).

All the components of the machine, from the footing 2 to the containers 49, 58 are made of fire-retardant materials, for example stainless steel, so as to eliminate the risks of flammability due to the use of alcohol-based solvents.

The operation of the washing machine according to the invention is as follows. First the printing plate 7 to be washed must be mounted on the machine.

If the printing plate 7 is not associated with any blanket (because they are not used with the blanket or because they have been removed from the blanket beforehand), it is necessary to mount the cylinder 18 along the supporting shaft 6 with the conical bushes 19, 20 and then fix the assembly inside the washing chamber 4, through the lateral hatch 8a; by subsequently using the pedal 73 to slowly turn the supporting shaft 6, the printing plate 7 is wound and fixed onto the cylinder 18 with double adhesive precisely and accurately through the upper hatch 5.

If instead the printing plate 7 is already fixed to a respective blanket 15, said blanket has to be mounted along the supporting shaft 6 by means of the conical bushes 19, 20 and optionally the flanges 21, 22 as well, in relation to the diameter of the blanket 15: the entire assembly must then be fixed within the washing chamber 4 by means of the lateral hatch 8a.

At this point, after closing hermetically and accurately the hatches 5, 8a, the first cycle for washing the printing plate 7 is started: in particular, the brush 9 is moved toward the printing plate 7 and the supporting shaft 6 and the brush 9 are turned in mutually opposite directions with respective rotation rates such that the relative peripheral speed of the printing plates and the brush is the optimum one, determined experimentally, for achieving the best conditions for removing the ink from the surface of the printing plate 7. These rotation rates are of course determined in relation to the diameter of the cylinder 18 or of the blanket 15.

During the rotation of the shaft 6 and of the brush 9, the first pump 50 is actuated and dispenses the first liquid, drawn from the first container 49, by means of the first spray duct 48; said first liquid, collected on the bottom 54, is made to flow out, by means of the first valve 56, through the first discharge port 55, and conveyed from there again to the first container 49. This step of washing with the first liquid can be repeated for a plurality of cycles in relation to specific requirements.

Subsequently, again during the rotation of the shaft 6 and of the brush 9, the second pump 59 is actuated, dispensing the second liquid, drawn from the second container 58, by means of the second spray duct 57; said second liquid, collected on the bottom 54, is made to flow out, by means of the second valve 64, through the second discharge port 63, and from there is conveyed again to the second container 58. Said second step of washing with the second liquid can be repeated for a plurality of cycles in relation to specific requirements, so as to obtain perfect rinsing of the printing plate 7.

Finally, at the end of the washing process, the air drying means 13 are activated inside the washing chamber 4.

It is noted that the supporting shaft 6, actuated by means of the pedal 73, can also be used advantageously to separate and reattach the printing plates 7 from and on the respective blankets 15, thus allowing to avoid the use of specifically provided printing plate mounting machines.

It has thus been shown that the invention achieves the intended aim and objects.

Washing printing plates without a blanket or separated beforehand from the respective blanket is particularly advantageous and effective, since it is performed on an auxiliary cylinder which is covered with double-adhesive material, which allows easier mounting.

Further, the brush positioning means allow to place said brush in contact, along generatrices, with printing plates which are mounted on blankets of any diameter and of any length, by way of the use of conical fixing bushes.

The term “substantially” as herein used, is intended to mean that every feature to which it refers has the very characteristics as indicated and well known in the art, but for shape or position tolerances that are known as normal and usual to those skilled in the art.

The invention thus conceived is susceptible of numerous modifications and variations, all of which are within the scope of the appended claims.

All the details may be replaced with other technically equivalent ones.

In practice, the materials used, as well as the shapes and dimensions, may be any according to requirements without thereby abandoning the scope of the protection of the appended claims.

The disclosures in Italian Patent Application No. BO2006A000334 from which this application claims priority are incorporated herein by reference.

What is claimed is:

1. A machine for washing flexographic printing plates, comprising: at least one substantially box-shaped footing which forms at least one chamber for washing printing plates; at least one shaft for supporting at least one printing plate in a substantially cylindrical configuration, which is arranged inside said washing chamber; first actuation means connected to said at least one shaft, for rotary actuation about an axis thereof; at least one brush, having an axis that is parallel to the axis of said at least one supporting shaft; second actuation means connected to said at least one brush for rotary actuation about an axis thereof; positioning means connected to said at least one brush for selective positioning thereof from at least one inactive configuration to at least one washing configuration, in which said at least one brush is substantially in contact with said printing plate along a generatrix; at least one circuit for washing the printing plate; drying means for drying a washed printing plate; first mounting means that are selectively connectable to said at least one shaft for mounting the printing plate removed directly from a printing cylinder or removed directly from a respective blanket; and second mounting means that are selectively connectable to said at least one shaft for mounting the printing plate which is fixed permanently to the respective blanket.

2. The washing machine of claim 1, comprising two conical bushes which are fitted along said at least one supporting shaft, said first mounting means for mounting the printing plate comprising at least one cylinder which is provided with a through axial channel for keying along said at least one supporting shaft and which is blocked at respective ends thereof by said two conical bushes, said at least one cylinder being covered with double-adhesive material for removable fixing, on its surface, of at least one printing plate to be washed.

3. The washing machine of claim 2, wherein said second mounting means for mounting the printing plate comprise at least one pair of conical bushes, which are fitted along said at least one supporting shaft, and at least one pair of respective flanges, which are substantially circular and have respective central holes, in which said conical bushes engage, said flanges having respective shoulders which are adapted to lock bilaterally each blanket along said supporting shaft at each of its ends.

4. The washing machine of claim 1, comprising at least one second gear which is keyed at an end of said at least one supporting shaft which protrudes externally from said footing, said first actuation means comprising at least one first gearmotor assembly, which is fixed externally to a side of the washing chamber and has at least one first output shaft with at least one first gear keyed thereon, said first gear meshing with said at least one second gear.

5. The washing machine of claim 1, wherein said second rotary actuation means comprise at least one second gearmotor assembly, which is fixed externally to one side of said footing and has at least one second output shaft, which is supported in said footing, at least one first pulley keyed at an end of said output shaft for actuating at least one belt for transmitting motion, and a second pulley, which is keyed to an end of a brush shaft for receiving motion from said belt.

6. The washing machine of claim 5, wherein said positioning means for selective positioning comprise bearings and at least one tubular body rotatably supported in said footing by way of said bearings, said tubular body having a proximal end to which at least one rocker is fixed rigidly, and two arms rigidly coupled to the tubular body in order to support rotatably ends of said brush shaft and extending to a region outside said footing with said proximal end and wherein at least one linear actuator is provided which has a first end thereof articulated to said footing, and a second end thereof articulated to said rocker, said at least one linear actuator having a stem which is actuatable so as to move from at least one retracted position, at which said at least one brush is in said inactive configuration, to at least one extended position, at which said at least one brush is in a configuration for washing the printing plate, so as to bring said at least one brush into contact, along a generatrix, with printing plates mounted on cylinders and/or blankets of different length and/or diameter.

7. The washing machine of claim 6, wherein said selective positioning means further comprise at least one return spring, which has a first end which is articulated to said rocker and a second end which is articulated to said footing, said return spring being adapted to keep said at least one brush in said inactive configuration.

8. The washing machine of claim 6, wherein said second output shaft is accommodated coaxially to and within said tubular body, said first pulley, said belt and said second pulley being accommodated within a box which is rigidly coupled to a distal end of said tubular body.

9. The washing machine of claim 6, wherein said at least one linear actuator is of a double-acting pneumatic type, and is coupled with respective pneumatic actuation means for providing actuation force.

10. The washing machine of claim 6, wherein said at least one washing circuit comprises: a first spray duct which is fixed, at ends thereof, to said arms and is provided with a plurality of openings distributed thereon for ejecting at least one first liquid; a first container for collecting said first liquid; a first pump for feeding said at least one first fluid, which is fixed to said footing; at least one first intake duct which is connected to said first pump and is adapted to draw the at least one first liquid from said first container; and at least one first delivery duct for said at least one first liquid which is connected respectively to said first pump and to said first spray duct.

11. The washing machine of claim 10, wherein said washing circuit further comprises a first discharge duct for discharging the at least one first liquid, which is connected to a bottom region of said washing chamber at a first discharge port and to said first container, said first discharge port being provided with a respective first valve for selective opening and closure.

12. The washing machine of claim 11, wherein said washing circuit further comprises: a second spray duct which is fixed, at ends thereof, to said arms and is provided with a plurality of ports for ejecting at least one second liquid; a respective second container for collecting said at least one second liquid; a second pump for supplying said at least one second liquid which is fixed to said footing; at least one second intake duct which is connected to said second pump and is adapted to draw the at least one second liquid from said second container; and at least one second duct for delivering said at least one second liquid which is connected respectively to said second pump and to said second spray duct.

13. The washing machine of claim 12, wherein said washing circuit comprises a second discharge duct for discharging the at least one second liquid, which is connected to a bottom region of said washing chamber at a second discharge port and to said second container, said second discharge port being provided with a respective second valve for selective opening and closure.

14. The washing machine of claim 13, wherein said first valve and said second valve are electropneumatic type valves and are functionally associated with said pneumatic actuation means.

15. The washing machine of claim 12, wherein said at least one first liquid is a liquid with a composition suitable for washing said printing plate.

16. The washing machine of claim 15, wherein said at least one second liquid is a liquid with a composition suitable for rinsing said printing plate after washing thereof.

17. The washing machine of claim 1, wherein said drying means comprise: at least one fan; a respective actuation motor connected with said fan; at least one tube connected to said fan for introducing air into said washing chamber; at least one port provided for discharging drying air from said washing chamber; and a discharge tube for discharging air externally that is connected to said at least one port.

18. The washing machine of claim 2, wherein said washing chamber comprises at least one upper hatch for mounting in and removing therefrom the printing plates.

19. The washing machine of claim 18, wherein said washing chamber comprises at least one lateral hatch for insertion therein and removal therefrom of said printing plate supporting cylinder or of said blanket from said supporting shaft.

20. The washing machine of claim 1, comprising at least one pedal for actuating said at least one supporting shaft, which is functionally connected to said first rotary actuation means and is adapted to turn said at least one supporting shaft during operations for mounting and removing the printing plate.

21. The washing machine of claim 13, wherein each of said first and second containers is provided with a respective coupling for connecting said first and second intake ducts and for said first and second discharge ducts, said respective coupling comprising an external tubular element inserted in a mouth part of said first and second containers and connected to said first and second discharge ducts and an inner tubular element having a diameter such as to allow insertion thereof within said external tubular element and being connected to said first and second intake ducts.
